(19) United States
(12) Patent Application Publication
(10) Pub. No.: US 2013/0007379 A1
(43) Pub. Date: Jan. 3, 2013

(54) SECURE AND VIRTUALIZABLE PERFORMANCE COUNTERS

(76) Inventors: Andrew G. Kegel, Redmond, WA (US); Stephen D. Glaser, San Francisco, CA (US)

(21) Appl. No.: 13/172,935

(22) Filed: Jun. 30, 2011

(51) Int. Cl. G06F 12/00

(52) U.S. Cl. 711/154; 711/E12.001

(57) ABSTRACT

A method includes updating contents of a value storage element indicating a number of occurrences of an event. The updating is based on contents of a match storage element storing event qualification information. The method includes providing the contents of the value storage element to a first software module executing on at least one processor. The providing is based on contents of a protect storage element indicating access information. In at least one embodiment, the method includes executing a first software module on the at least one processor in a first mode of operation. In at least one embodiment, the method includes executing a second software module on the at least one processor in a second mode of operation. In at least one embodiment, the second mode is more privileged than the first mode.

### BACKGROUND

1. Field of the Invention

The invention is related to computing systems and more particularly to performance counters of computing systems.

2. Description of the Related Art

In general, a computing system adjusts operational parameters (e.g., hardware and software parameters) to improve performance. However, policies and computations may be so complex that software, rather than hardware, is used to adjust those operational parameters. The hardware typically provides one or more performance counters to track the occurrence of corresponding events or indicators of hardware performance. User-level processes are typically blocked from accessing those performance counters based on a corresponding privilege level. In a typical non-virtualized system (FIG. 1), the operating system monitors the performance counters and adjusts the system accordingly. In a typical virtualized system (FIG. 2), a virtual machine monitor (i.e., hypervisor) monitors the performance counters and adjusts the system accordingly. Only the virtual machine monitor or the operating system can access the performance counters, not both. In general, a user-level process cannot access the performance counters to prevent a user-level process from having access to system information that may be used to subvert system security measures. Otherwise, user-level access to performance counters may be used as a backdoor to communicate information through an unauthorized channel, the counters may be used by less-privileged software to gain unauthorized information about more privileged software, and/or the performance counters may be used to mount a denial-of-service attack against other software.

The requirement that only the most privileged software can access performance counters limits the performance information that is available to other, less-privileged software. The less-privileged software may receive performance information from the more privileged software layers using, e.g., software emulation, system calls, or hypercalls, which are all operations that have significant performance costs that result in poorly resolved or late information, causing improper application of policies and thus reduced system performance. Performance information may not be available at all to the less-privileged software, leaving the less-privileged software unable to modify its operational parameters in response to dynamic system changes, resulting in degraded performance.

### SUMMARY OF EMBODIMENTS OF THE INVENTION

In at least one embodiment of the invention, a method includes updating contents of a value storage element indicating a number of occurrences of an event. The updating is based on contents of a match storage element storing event qualification information. The method includes providing the contents of the value storage element to a first software module executing on at least one processor. The providing is based on contents of a protect storage element indicating access information. In at least one embodiment, the method includes executing a first software module on the at least one processor in a first mode of operation. In at least one embodiment, the method includes executing a second software module on the at least one processor in a second mode of operation. In at least one embodiment, the second mode is more privileged than the first mode.

In at least one embodiment of the invention, an apparatus includes a match storage element configured to store event qualification information. The apparatus includes a value storage element configured to accumulate occurrences of an event in response to an indicator indicating detection of the event based on contents of the match storage element. The apparatus includes a protect storage element configured to store information indicating access to the value storage element by a software module executing on at least one processor. The apparatus includes a control module configured to provide, to the software module, read access to contents of the value storage element based on contents of the protect storage element.

In at least one embodiment of the invention, a tangible computer-readable medium encodes a representation of an integrated circuit that comprises a match storage element configured to store event qualification information. The apparatus includes a value storage element configured to accumulate occurrences of an event in response to an indicator indicating detection of the event based on contents of the match storage element. The apparatus includes a protect storage element configured to store information indicating access to the value storage element by a software module executing on at least one processor. The apparatus includes a control module configured to provide, to the software module, read access to contents of the value storage element based on contents of the protect storage element.

In at least one embodiment of the invention, a computer program product encoded in one or more tangible machine-readable media includes a first sequence of instructions executable with a first privilege level to configure a match storage element to store event qualification information. The computer program product includes a second sequence of instructions executable with the first privilege level to update an operating parameter of a system executing the computer program product based on contents of a value storage element configured to accumulate occurrences of an event detected based on contents of the match storage element.

In at least one embodiment of the invention, a computer program product encoded in one or more tangible machine-readable media includes a first sequence of instructions executable with a privilege level higher than a user privilege level. The first sequence of instructions is executable to configure a protect storage element to store information indicating access to a value storage element. The first sequence of instructions is executable to configure a match storage element by a sequence of instructions executable with the user privilege level.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a block diagram of software module access to performance counters in an exemplary non-virtualized processing system.

FIG. 2 illustrates a block diagram of software module access to performance counters in an exemplary virtualized processing system.

FIG. 3 illustrates a block diagram of an exemplary processing system consistent with at least one embodiment of the invention.

FIG. 4 illustrates a block diagram of an exemplary virtualized processing system consistent with at least one embodiment of the invention.

FIG. 5 illustrates a block diagram of an exemplary performance counter module and related modules consistent with at least one embodiment of the invention.

FIG. 6 illustrates a block diagram of an exemplary set of storage elements of the performance counter module of FIG. 5 consistent with at least one embodiment of the invention.

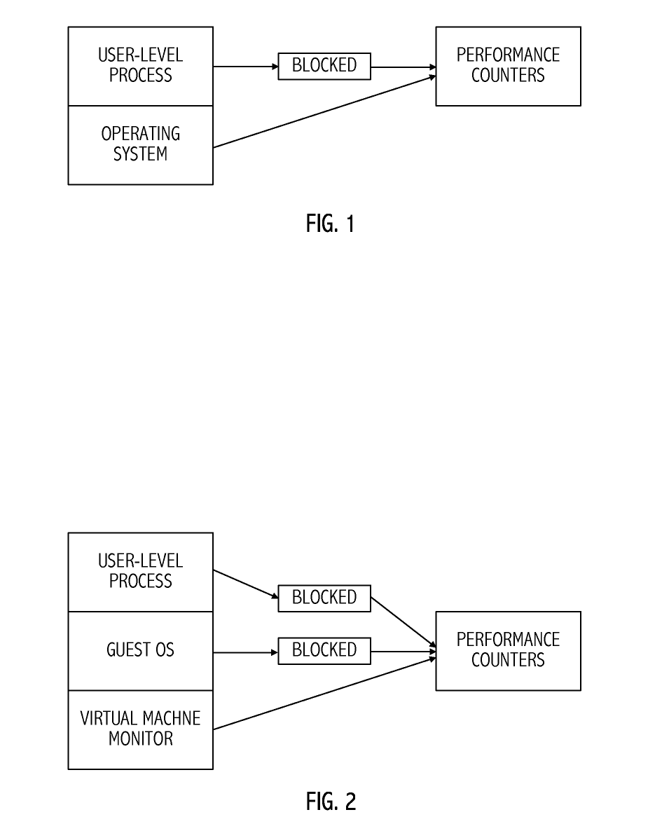

The use of the same reference symbols in different drawings indicates similar or identical items.

### DETAILED DESCRIPTION

A technique for providing secure and virtualizable performance counters facilitates access to the performance counters by software modules having different privilege levels. As referred to herein, a software module is a program, process, or procedure that includes a set of instructions for controlling one or more portions of a computing system. Event count information is stored and managed by a performance counter module that includes value registers (i.e., storage elements) and associated control registers. The technique provides user-level software modules, as well as higher-privileged software modules, efficient access to performance information, which allows those software modules to respond quickly and precisely to system operational changes.

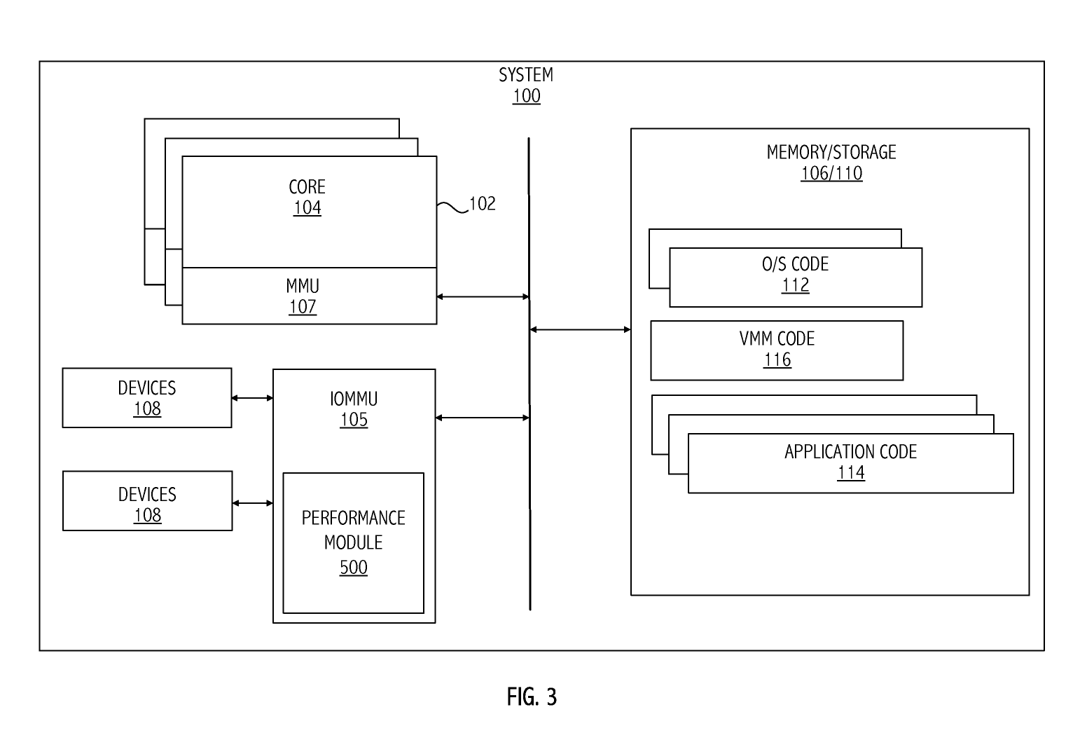

Referring to FIG. 3, an exemplary processing system (e.g., processing system 100) includes at least one processor (i.e., central processing unit, digital signal processor, graphics processor, e.g., processors 102) that includes one or more processor cores (i.e., cores, e.g., processor cores 104). Processors 102 are coupled to other processors 102, memory 106, devices 108, and storage 110 directly or by one or more hub integrated circuits (e.g., memory controller hub and I/O controller hub), bus (e.g., PCI bus, ISA bus, and SMBus), other suitable communication interfaces, or combinations thereof. In at least one embodiment of processing system 100, processors 102 are coupled to main memory via a memory management unit (e.g., MMU 107). The memory management unit coordinates memory accesses between processors 102 (e.g., a central processing unit, digital signal processor, and/or graphics processor) and memory 106. Functions of the MMU include translation of virtual addresses to physical addresses, memory protection, cache control, and bus arbitration. In addition, the MMU provides hardware performance information to software executing on a processor (e.g., a central processing unit, digital signal processor, or graphics processor) that manages the MMU. The software uses that hardware performance information to adjust operational parameters of the hardware and the software to obtain improved performance. In at least one embodiment of processing system 100, the hardware performance information includes statistics regarding use of in-chip cache memory. The software reports that information to the programmer, which uses the information to modify software code to utilize the cache more efficiently. In at least one embodiment of processing system 100, the hardware performance information includes a number of soft error correction code errors, which is used by software to determine when to recommend replacement of failing memory. In at least one embodiment of processing system 100, the hardware performance information includes thermal information that software uses to adjust a workload to maintain operating temperature within a particular temperature range. An operating system (e.g., Microsoft Windows, Linux, and UNIX) provides an interface between the hardware and a user (i.e., computing applications, e.g., application code 114 executing on one or more of processors 102). Execution of system software (e.g., operating system 112 or VMM code 116) may be distributed across a plurality of processors 102 and/or cores 104.

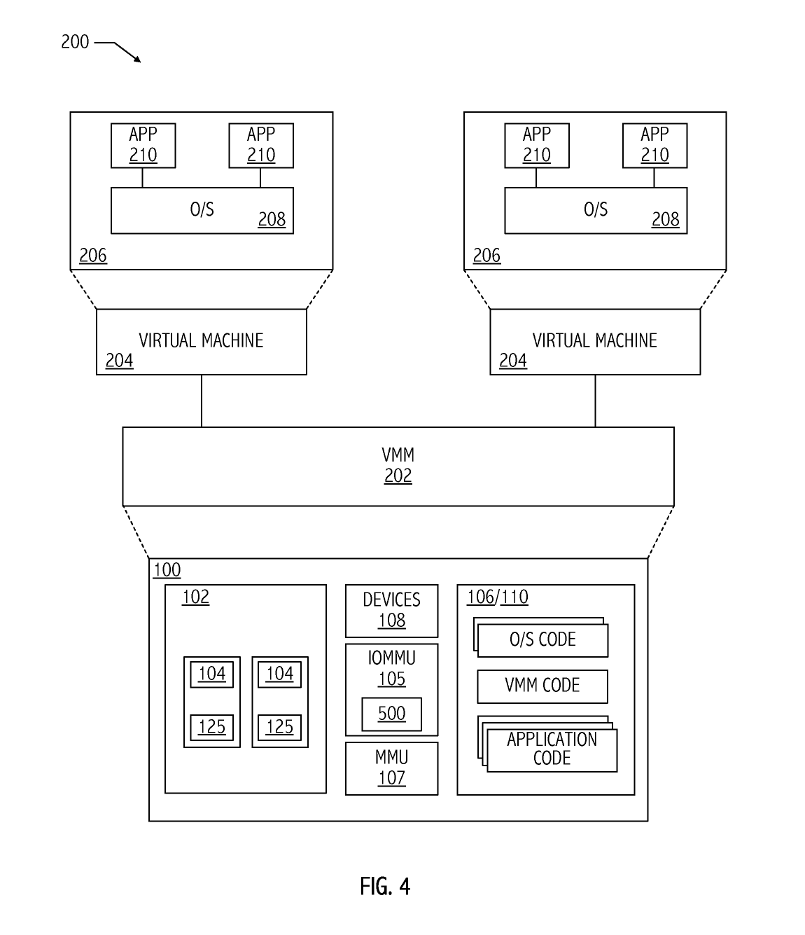

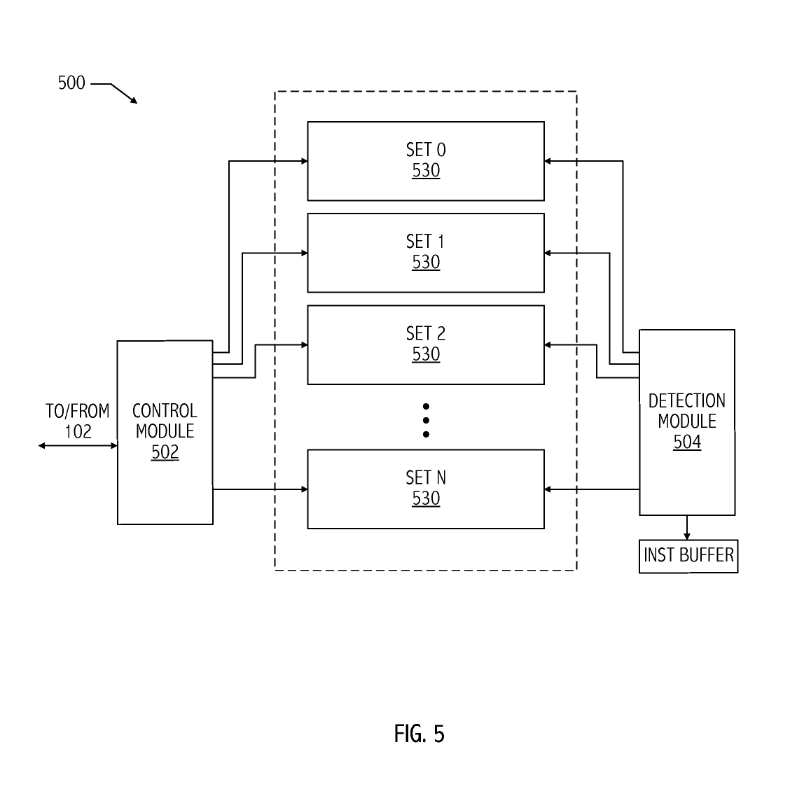

Referring to FIG. 4, virtualization of a computing system hides physical characteristics of the computing system from a user or guest (i.e., software executing on the computing system) and instead, presents an abstract emulated computing system (i.e., a virtual machine (VM)) to the user or guest. Physical hardware resources of processing system 100 are exposed to one or more users or guests (e.g., guests 206) as one or more corresponding isolated, apparently independent, virtual machines (e.g., VM 204). For example, a virtual machine may include one or more virtual resources (e.g., VCPU, VMEMORY, and VDEVICES) that are implemented by physical resources of processing system 100 that a virtual machine monitor (VMM) (i.e., hypervisor, e.g., VMM 202) allocates to the virtual machine.

As referred to herein, a “virtual machine monitor” (VMM, e.g., VMM 202) or “hypervisor” is software that provides the virtualization capability. The VMM provides an interface between the user or guest and the physical resources. Typically, the VMM provides each guest the appearance of full control over a complete computer system (i.e., memory, central processing unit (CPU) and all peripheral devices). A Type 1 (i.e., native) VMM is a standalone software program that executes on physical resources and provides the virtualization for one or more guests. A guest operating system executes on a level above the VMM. A Type 2 (i.e., hosted) VMM is integrated into or executes on an operating system, the operating system components execute directly on physical resources and are not virtualized by the VMM. The VMM is considered a distinct software layer and a guest operating system may execute on a third software level above the hardware. Techniques described herein may be implemented using a Type 1 VMM, a Type 2 VMM or other suitable VMM.

Still referring to FIG. 4, while guest 206 has full control over the virtual resources of virtual machine 204, VMM 202 retains control over the physical resources. A guest system, e.g., an instance of an operating system (e.g., Windows, Linux, and UNIX) executes on a corresponding virtual machine and shares physical resources with other guest systems executing on other virtual machines. Thus, multiple operating systems (e.g., multiple instances of the same operating system or instances of different operating systems) can co-exist on the same computing system, but in isolation from each other.

In at least one embodiment of processing system 200, VMM 202 is executed by some or all processor cores in the physical resources of processing system 200. An individual guest 206 is executed by one or more of the processor cores included in the physical resources. The processors switch between execution of VMM 202 and execution of one or more guests 206. As referred to herein, a “world switch” is a switch between execution of a guest (i.e., a software module executing in a guest mode of processing system 200) and execution of a host (i.e., a software module executing in a privileged or host mode of processing system 200, e.g., executing VMM 202) or vice versa. In general, a world switch may be initiated by a VMRUN instruction of an AMD Secure Virtual Machine, a VMLAUNCH or VMRESUME virtual machine extension instruction of an Intel virtual machine, interrupt mechanisms, exception mechanisms, predetermined instructions defined by a control block (e.g., VMMCALL), or by other suitable technique. During a world switch, a current processor environment (e.g., processor core(s) executing guest 206 in guest mode or executing VMM 202 in host mode) saves its state information and restores state information for a target processor environment (e.g., processor core(s) executing VMM 202 in host mode or executing guest 206 in guest mode) to which the processor execution is switched. For example, VMM 202 initiates a world switch when VMM 202 executes a guest 206 that was scheduled for execution. Similarly, a world switch from executing guest 206 to executing VMM 202 is made when VMM 202 exercises control over physical resources, e.g., when guest 206 attempts to access a peripheral device, when guest 206 attempts to access a performance counter, when a new page of memory is to be allocated to guest 206, or when it is time for VMM 202 to schedule another guest 206, etc. A typical world switch can take thousands of cycles.

Virtualization techniques may be implemented using only software (which includes firmware) or by a combination of software and hardware (which includes microcode). For example, some processors include virtualization hardware, which allows simplification of VMM code and improves system performance for full virtualization (e.g., hardware extensions for virtualization provided by AMD-V and Intel VT-x). For example, AMD-V is an AMD64 extension that effectively provides a super-privileged operating mode in which a VMM can control a guest operating system.

In at least one embodiment of system 100, rather than requiring the VMM to emulate devices to route I/O requests from guest operating system drivers to manage access to common memory space and to restrict real device access to kernel mode drivers, virtualization techniques are further supported by IOMMU 105. IOMMU 105 is an MMU that couples a Direct Memory Access (DMA) capable input/output (I/O) bus to memory 106. As described above, MMU 107 translates processor-visible virtual addresses to physical addresses. Similarly, IOMMU 105 translates device-visible virtual addresses (i.e., device addresses or I/O addresses) to physical addresses. In at least one embodiment, IOMMU 105 provides DMA address translation and permission checking for device reads and writes. IOMMU 105 allows an unmodified driver in a guest OS to directly access a target device, without the overhead of running through a VMM (i.e., without a world switch) and without device emulation.

In at least one embodiment, IOMMU 105 translates addresses from device requests in system memory addresses and checks appropriate permissions on each access to provide memory protection from misbehaving devices. In at least one embodiment, IOMMU 105 is included as part of a HyperTransport™ or PCI bridge device. Embodiments of system 100 that include multiple HyperTransport™ links between processors and I/O hubs also include multiple IOMMUs. In at least one embodiment, IOMMU 105 assigns each of device(s) 108 a protection domain that defines I/O page translations used for each device in the domain. The protection domain specifies access permissions for each I/O page. In at least one embodiment, VMM 202 assigns all devices assigned to a particular guest operating system 208 the same protection domain, which creates a consistent set of address translations and access restrictions used by all devices running under control of the particular guest operating system 208. In at least one embodiment, VMM 202 configures I/O page tables to map system physical addresses to guest physical addresses, configures a protection domain for guest operating system 208, and then allows guest operating system 208 to execute. Drivers written for the real device execute as part of guest operating system 208 unmodified and unaware of underlying translations. Guest operating system transactions are isolated from those of other guests by I/O mapping provided by IOMMU 105.

In at least one embodiment, IOMMU 105 includes performance counter module 500, which facilitates secure and virtualizable performance counters. In at least one embodiment of system 200, performance counter module 500 is located in a separate module coupled between IOMMU and memory 106. Referring to FIG. 5, in at least one embodiment, performance counter module 500 includes multiple sets of registers (i.e., multiple sets of storage elements, e.g., register sets 530) and associated circuits (e.g., control module 502 and detection module 504) that are configured to be secure and virtualizable performance counters. In at least one embodiment, each set of registers is associated with special, known addresses. In at least one embodiment of performance counter module 500, each set of registers is associated with special, known offsets from a base address associated with IOMMU 105. In at least one embodiment of performance counter module 500, the register sets are memory-mapped I/O. Properties of the virtual memory management subsystem are used to set permissions to protect access to those registers. For example, the performance counters may be aligned at memory address boundaries that match the memory page granularity (e.g., 4 kilobyte (KB) page boundaries for an x86 architecture). The memory address boundaries can have any values that align with page-protection granularity of the host system (e.g., 512 bytes, 8 KB, or 2 megabytes (MB)). This allows privileged software to independently assign individual sets of performance counters to particular software components. For example, referring to FIGS. 2 and 5, a set of performance counters (e.g., SET 0) may be reserved for virtual machine monitor 202, while one or more other sets of performance counters (e.g., SET 1) are reserved for each guest operating system 208, and still other sets of performance counters (e.g., SET 2 . . . N) are reserved for user-level processes 210 of a particular guest operating system 208. In at least one embodiment of system 200, virtual machine monitor 202 allocates the sets of performance counters dynamically and arbitrarily, i.e., any particular set of performance counters can be assigned to any particular software module, and the allocation can be changed during system operation.

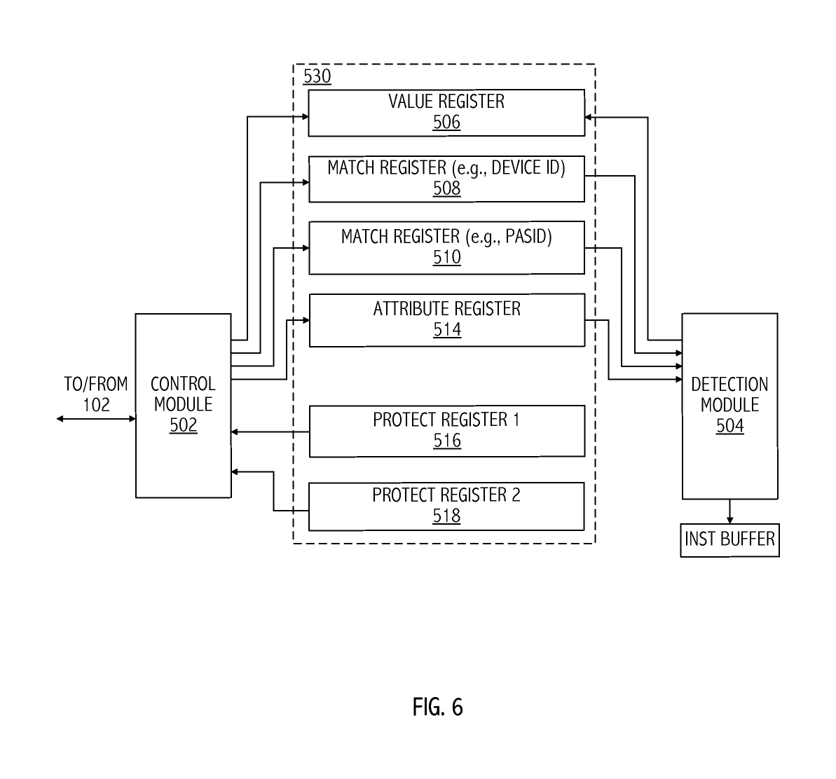

Referring to FIG. 6, in at least one embodiment of performance counter module 500, an individual register set 530 includes a count register (e.g., value register 506) and at least one corresponding control register (e.g., match register 508 and match register 510) that software uses to specify which event(s) to count using the particular performance counter. In at least one embodiment, value register 506 is configured to accumulate performance information based on the contents of at least one corresponding match register 508. A module (e.g., control module 502, which may include hardware and/or firmware) configures hardware (e.g., register set 530 and detection module 504) to select events to be counted based on configuration information received from software. For example, an application 210, an operating system 208, or virtual machine monitor 202 executing on one or more of processors 102 may include instructions for at least partially configuring a register set 530 as part of a performance counter. Execution of those instructions communicates information to control module 502 for configuration of register set 530 for a particular software module.

In at least one embodiment of performance counter module 500, match register 508 is configured to select a particular device for events that are counted based on a device identifier (DeviceID). In at least one embodiment of performance counter module 500, match register 510 is configured to select a Process Address Space Identifier (PASID) that is used to identify an application address space within an x86-canonical guest virtual machine. It is used on a peripheral to isolate concurrent contexts residing in a shared local memory. Together, the PASID and DeviceID information uniquely identify an application address space. Note that use of the PASID and DeviceID for specifying an event to be counted is exemplary only and the match register(s) may be configured for events qualified based on additional or other criterion. In at least one embodiment, the match registers include a field that can be used to cause the hardware to ignore actual comparison results and always indicate no match. That field may be used to disable counting of events (e.g., temporarily). In at least one embodiment, the match registers include a field that can be used to cause the hardware to ignore actual comparison results and always indicate a match. That field is useful to match on all PASID values or match on all Device ID values. In at least one embodiment, the match registers include a filter field that causes the hardware to ignore certain bits of a field in a comparison. That field is useful to count events for select groups of values (e.g., count events for all PASID values from 0 through 6, inclusively, or count events for all DeviceIDs from 0 to 127). In at least one embodiment, the match registers include a min and/or max field so that the comparison is for a range of values, as programmed by software. Note that combinations of multiple match registers may be configured in complex ways to at least partially determine an event to be counted.

In at least one embodiment of performance counter module 500, each performance counter is associated with one or more attribute registers (e.g., attribute register 514) that is configured to select the type of event to be counted for the device specified by one or more corresponding match registers (e.g., match register 508 and match register 510). For example, an attribute register may indicate that the event is a hit of a Translation Lookaside Buffer (TLB) of the IOMMU for a selected value of a DeviceID and a selected value of PASID. Other events that may be counted include a number of interrupts, a number of page faults, a number of instructions executed, a number of I/O operations processed, and a number of times an attempt to read memory is satisfied by a cache. For security purposes, one or more of those parameters (e.g., one or more of the contents of the match registers and attribute registers) are locked, e.g., a user-level process is not allowed to change the DeviceID although the user-level process may be allowed to change the event being counted (e.g., TLB hit) or the PASID being matched.

In at least one embodiment of performance counter module 500, protection above and beyond the protection provided by memory page access controls includes providing one or more protect registers (e.g., protect register 516 and protect register 518) that indicate to control module 502 whether or not a particular register of register set 530 can be changed or viewed by a particular software module. In at least one embodiment of performance counter module 500, at least one protect register is configured to determine whether or not value register 506, match register 508, match register 510, and/or attribute register 514 can be modified by a particular software module. In at least one embodiment, the protect registers allow more privileged software to decide which devices and registers may be viewed and/or changed by less privileged software modules. Access control can be provided on a register-by-register basis. In at least one embodiment of performance counter module 500, one or more protect registers controls whether or not the corresponding match register can be written by a particular software module. In other embodiments of performance counter module 500, a read of the match register by a particular software module may be obscured by control module 502 based on contents of the protect register(s).

In at least one embodiment of performance counter module 500, virtual machine monitor 202 retains control over the protect register(s) and determines whether or not a particular software module (e.g., a guest operating system or a user-level process) may view or change the corresponding match register(s) of the register set for the performance counter. In at least one embodiment of performance counter module 500, a protect register is configured to prevent a user-level process from directly changing either the PASID or DeviceID programmed into the match registers unless the process makes the change request via the associated operating system. In at least one embodiment of performance counter module 500, a protect register is configured to prevent a guest operating system from changing the DeviceID programmed into a match register unless it makes the change request via the virtual machine monitor, but is configured to allow change to the PASID programmed into a corresponding match register. In at least one embodiment of performance counter module 500, one or more protect registers are configured to allow virtual machine monitor 202 to change the contents of any register in register set 530 and can do so by retaining control of the associated protect register(s).

In at least one embodiment of performance counter module 500, detection module 504 compares the contents of an IOMMU instruction buffer to the contents of at least one control register (e.g., match register) in register set 503. If detection module 504 detects a match for those control registers associated with a particular value register for a current event consistent with any corresponding attribute register, then the event is detected and detection module 504 updates the value register accordingly (e.g., increments or decrements the value register according to the design of the value register). The contents of the value register are made accessible to one or more software modules by the IOMMU and/or based on any corresponding protect register of performance module 500. The software module may then use the information in the value register to update system parameters.

Thus, performance counter module 500 allows different software modules to receive performance information that is of interest to the particular software module and/or according to the privilege level of that software module. Those register sets 530 and associated modules (e.g., control module 502 and detection module 504) provide fast access to the most current information to software modules having different levels of privilege, while reducing or preventing opportunities for less privileged processes to perturb this information. The techniques described herein may be applied to additional levels of privilege and domains of isolation.

As described above, the techniques described herein allow less-privileged software to efficiently and quickly access IOMMU performance counter information with relatively low overhead (i.e., the cost of a hardware access rather than the cost of software-mediated access, which may require a world switch). Meanwhile, the virtual machine monitor and operating system retain control of changes to the information, thereby maintaining system isolation and protection properties. Instead of taking dozens, hundreds, or even thousands of instructions to read or change performance information, a read of performance information consistent with the techniques described herein only takes a few cycles. Accordingly, software can obtain accurate, current performance information at any rate that it determines is necessary without throttling access or sampling rates, and without deferring usage of the performance information. As a result, software can adapt quickly and efficiently to changes in system behavior. In embodiments of system 200 that allocate much control of the system to threads and user-level processes executing on the system, performance counter module 500 allows those threads and user-level processes to efficiently access performance information and respond quickly and precisely to system operational changes.

While circuits and physical structures have been generally presumed in describing embodiments of the invention, it is well recognized that in modern semiconductor design and fabrication, physical structures and circuits may be embodied in computer-readable descriptive form suitable for use in subsequent design, simulation, test or fabrication stages. Structures and functionality presented as discrete components in the exemplary configurations may be implemented as a combined structure or component. Various embodiments of the invention are contemplated to include circuits, systems of circuits, related methods, and tangible computer-readable medium having encodings thereon (e.g., VHSIC Hardware Description Language (VHDL), Verilog, GDSII data, Electronic Design Interchange Format (EDIF), and/or Gerber file) of such circuits, systems, and methods, all as described herein, and as defined in the appended claims. In addition, the computer-readable media may store instructions as well as data that can be used to implement the invention. The instructions/data may be related to hardware, software, firmware or combinations thereof.

Structures described herein may be implemented using software executing on a processor (which includes firmware) or by a combination of software and hardware. Software, as described herein, may be encoded in at least one tangible computer readable medium. As referred to herein, a tangible computer-readable medium includes at least a disk, tape, or other magnetic, optical, or electronic storage medium.

The description of certain embodiments of the invention set forth herein is illustrative, and is not intended to limit the scope of the invention as set forth in the following claims. For example, while the invention has been described in an embodiment in which performance counters for events of an IOMMU are managed, one of skill in the art will appreciate that the teachings herein can be utilized with performance counters associated with other control modules of a computing system, and performance counter module 500 may be located and configured accordingly. For example, techniques described herein may be applied to MMU 107, performance counters for processors 102, devices 108, memory 106/110 and/or other system modules having events to be counted. Variations and modifications of the embodiments disclosed herein, may be made based on the description set forth herein, without departing from the scope and spirit of the invention as set forth in the following claims.

What is claimed is:

1. A method comprising:
updating contents of a value storage element indicating a number of occurrences of an event, the updating being based on contents of a match storage element storing event qualification information; and
providing the contents of the value storage element to a first software module executing on at least one processor, the providing being based on contents of a protect storage element indicating access information.

2. The method, as recited in claim 1, further comprising:
executing the first software module on the at least one processor in a first mode of operation; and
executing a second software module on the at least one processor in a second mode of operation, the second mode being more privileged than the first mode.

3. The method, as recited in claim 2, wherein the first software module is a user application or a guest under control of a virtual machine monitor.

4. The method, as recited in claim 2, wherein the second software module is a virtual machine monitor or a guest executing under control of a virtual machine monitor.

5. The method, as recited in claim 2, further comprising:
configuring the protect storage element to allow access of the match storage element to the first software module in the second mode of operation.

6. The method, as recited in claim 2, further comprising:
configuring the protect storage element to allow read access of the value storage element to the first software module in the second mode of operation.

7. The method, as recited in claim 1, further comprising:
updating an operational parameter by the first software module based on contents of the value storage element, wherein the first software module has only user-level privileges.

8. The method, as recited in claim 1, further comprising:
configuring the protect storage element by a second software module executing on the at least one processor; and
resetting the value storage element by the second software module.

9. The method, as recited in claim 8, further comprising:
configuring the match storage element and the attribute storage element by the first software module, the first software module being less privileged than the second software module.

10. The method, as recited in claim 8, further comprising:
configuring the match storage element and the attribute storage element by the second software module; and
prohibiting access of the first software module to the match storage element.

11. The method, as recited in claim 1, wherein the contents of the match storage element indicate a device corresponding to the event and the updating is further based on contents of an attribute storage element containing an indication of a type of the event.

12. The method, as recited in claim 1, wherein the event is a translation lookaside buffer hit, an interrupt, a page fault, or a cache hit.

13. The method, as recited in claim 1, wherein the event is an input/output memory management unit (IOMMU) event.

14. An apparatus comprising:
a match storage element configured to store event qualification information;
a value storage element configured to accumulate occurrences of an event in response to an indicator indicating detection of the event based on contents of the match storage element;
a protect storage element configured to store information indicating access to the value storage element by a software module executing on at least one processor; and
a control module configured to provide, to the software module, read access to contents of the value storage element based on contents of the protect storage element.

15. The apparatus, as recited in claim 14, further comprising:
a detection module configured to generate the indicator in response to detecting the event based on contents of the match storage element.

16. The apparatus, as recited in claim 14, wherein the control module is further configured to provide, to the software module, write access to the match storage element based on the contents of the protect storage element.

17. The apparatus, as recited in claim 14,
wherein the match storage element is configured to indicate a device corresponding to the event being counted.

18. The apparatus, as recited in claim 14, further comprising:
an attribute storage element configured to store additional event qualification information,
wherein the detection module is configured to generate the indicator further based on contents of the attribute storage element.

19. The apparatus, as recited in claim 18,
wherein the attribute storage element is configured to indicate that the event is a translation lookaside buffer hit, an interrupt, a page fault, or a cache hit.

20. The apparatus, as recited in claim 14, further comprising:
at least one processor operable to execute a second software module in a first mode of a virtualized processing system and operable to execute the software module in a second mode of the virtualized processing system, the first mode being more privileged than the second mode,
wherein the second software module is executable to configure the protect storage element and the match storage element.

21. The apparatus, as recited in claim 14, wherein the apparatus forms a portion of an input/output memory management unit (IOMMU).

22. A tangible computer-readable medium encoding a representation of an integrated circuit that comprises:
a match storage element configured to store event qualification information;
a value storage element configured to accumulate occurrences of an event in response to an indicator indicating detection of the event based on contents of the match storage element;
a protect storage element configured to store information indicating access to the value storage element by a software module executing on at least one processor; and
a control module configured to provide, to the software module, read access to contents of the value storage element based on contents of the protect storage element.

23. The tangible computer-readable medium, as recited in claim 22, wherein the integrated circuit further comprises a detection module configured to generate the indicator in response to detecting the event based on contents of the match storage element.

24. The tangible computer-readable medium, as recited in claim 23, wherein the integrated circuit further comprises:
an attribute storage element configured to store additional event qualification information,
wherein the detection module is configured to generate the indicator further based on contents of the attribute storage element.

25. A computer program product encoded in one or more tangible machine-readable media, the computer program product comprising:
a first sequence of instructions executable with a first privilege level to configure a match storage element to store event qualification information; and
a second sequence of instructions executable with the first privilege level to update an operating parameter of a system executing the computer program product based on contents of a value storage element configured to accumulate occurrences of an event detected based on contents of the match storage element.

26. The computer program product, as recited in claim 25, further comprising:
a third sequence of instructions executable with a second privilege level, the second privilege level being higher than the user privilege level, the third sequence of instructions being executable to configure a protect storage element to store information indicating access to the value storage element by a sequence of instructions executable with the user privilege level.

27. The computer program product, as recited in claim 25, wherein the event is associated with an input/output memory management unit (IOMMU) event.

28. A computer program product encoded in one or more tangible machine-readable media, the computer program product comprising:
a first sequence of instructions executable with a privilege level higher than a user privilege level, the first sequence of instructions being executable to configure a protect storage element to store information indicating access to a value storage element and a match storage element by a sequence of instructions executable with the user privilege level.

29. The computer program product, as recited in claim 28, wherein the event is associated with an input/output memory management unit (IOMMU) event.
